(19) United States
(12) Patent Application Publication
(10) Pub. No.: US 2026/0234464 A1
(43) Pub. Date: Aug. 13, 2026

(54) POLYALKYL PHOSPHONATED POLYOL ETHER BASED SCALE INHIBITORS

(71) Applicant: ChampionX LLC, Sugar Land, TX (US)

(72) Inventors: Gedeng RUAN, Houston, TX (US); Clare Johnston, Aberdeen (GB); Chris Popeney, II, Sugar Land, TX (US); Wei Lu, Houston, TX (US)

(21) Appl. No.: 19/161,190

(22) PCT Filed: Feb. 29, 2024
(86) PCT No.: PCT/US2024/017828

§ 371 Date: Aug. 29, 2025

Related U.S. Application Data
(60) Provisional application No. 63/488,390, filed on Mar. 3, 2023.

(51) Int. Cl. C09K 8/528; C07F 9/38

(52) U.S. Cl. CPC C09K 8/528; C07F 9/3817

(57) ABSTRACT

Scale inhibitor compositions that include at least one polyalkyl phosphonated polyol ether. A method of inhibiting scale that includes contacting an aqueous fluid with a scale inhibitor composition comprising at least one polyalkyl phosphonated polyol ether.

### CROSS-REFERENCE TO RELATED APPLICATIONS

This application is a filing under 35 U.S.C. 371 of International Application No. PCT/US2024/017828 filed Feb. 29, 2024, entitled “POLYALKYL PHOSPHONATED POLYOL ETHER BASED SCALE INHIBITORS,” which claims priority to U.S. Provisional Application No. 63/488,390, filed Mar. 3, 2023, which applications are incorporated by reference herein in their entirety.

### FIELD OF THE DISCLOSURE

The present disclosure generally relates to scale inhibitor compositions and methods, and more particularly, to scale inhibitor compositions and methods utilizing polyalkyl phosphonated polyol ethers.

### BACKGROUND

Scale formation is a problem in many situations including oilfield (surface and sub-surface operations), industrial water treatment, laundry, detergent, industrial and household cleaning applications. Generally speaking, the problem arises because the aqueous system contains cations, such as calcium, barium, and magnesium along with anions such as bi-carbonate, carbonate, and sulfate. If the combination of cations and anions remain solubilized within the water, they typically do not cause concern. However, if the systems are perturbed in any way, leading to the concentration of ions present exceeding the solubility limits for that particular water, precipitation of scale can occur. These perturbations can include water evaporation (concentration), mixing of incompatible waters, pH changes, as well as pressure or temperature changes. Common scales include calcium carbonate (CaCO₃), barium sulfate (BaSO₄) and strontium sulfate (SrSO₄), but may also include other scales such as iron sulfide (FeₓS_{y}) or lead sulfide (PbS). If left untreated, scale deposits can have adverse effects including general fouling, reductions in the efficiency of a plant or equipment, mechanical failures, harboring bacteria, increased corrosion, or causing systems to be shut down for remediation.

Threshold scale inhibitors are used to mitigate scale deposition, and these scale inhibitors can include phosphates, phosphate esters, phosphonates, and polymeric agents. Phosphonates encompass the group of molecules characterized by the presence of a covalent carbon-to-phosphorus (C—P) bond, having the general formula: —R—P(O)(OH)₂, where R represents an alkyl group, such as a methyl group, an ethyl group, or a butyl group. Replacing the hydrogen (H) atom of one or more of the —OH groups with a monovalent cation such as sodium or potassium, a divalent cation such as calcium, or a nitrogen containing species such as ammonia or an amine, or combinations thereof, produces a “phosphonate salt.”

A particular type of phosphonates is amino phosphonates, which are molecules characterized by the formula: —N(R2)-R1-P(O)(OH)₂ where R1 represents an alkyl group as described above, and where R2 is selected from H, a second alkyl phosphonate group or another substituent such as —R1OH, etc. These molecules can be prepared as shown, or in the form of a previously described phosphonate salt.

A commonly used amino phosphonate for scale inhibition is diethylenetriamine penta(methylene phosphonic acid), also known as DTPMP. DTPMP is no longer favored for scale inhibition because of toxicity to the environment, and alternatives are desired that are more environmentally friendly. Moreover, it is desired that alternatives can inhibit scale to a degree comparable to that of DTPMP.

### SUMMARY

Aspects of the present disclosure relate to scale inhibitor compositions and methods of inhibiting scale.

A scale inhibitor composition can include at least one polyalkyl phosphonated polyol ether disclosed herein, such as a polyalkyl phosphonated polyol ether having a structure represented by Formula I, Formula II, Formula IIa, Formula IIb, Formula IIc, Formula IIa1, Formula IIa2, Formula IIa3, Formula IIa4, Formula IIb1, Formula IIc1, or combinations thereof.

An aqueous fluid can include water and the scale inhibitor composition.

A method can include contacting an aqueous fluid with a scale inhibitor composition comprising at least one polyalkyl phosphonated polyol ether. In several aspects, method includes introducing the scale inhibitor composition into a subterranean formation via a wellbore. In several aspects, the method includes, prior to introducing the scale inhibitor composition into a subterranean formation via a wellbore, stopping production of a production fluid from the wellbore. In several aspects, the method includes producing a production fluid from a subterranean formation via a production wellbore. In several aspects, the method includes introducing the scale inhibitor composition into the subterranean formation via an injection wellbore or into the production fluid in the production wellbore, optionally while the production fluid is flowing in the production. In several aspects, the method includes receiving a production fluid from a wellbore. In several aspects, the method includes introducing the scale inhibitor composition into the production fluid.

Other technical features may be readily apparent to one skilled in the art from the following figures, descriptions, and claims.

### DETAILED DESCRIPTION

The terms “phosphonate” and “phosphonate group” as used herein refers to —RP(O)(OH)₂, where R represents an alkyl group, such as a methyl group, an ethyl group, or a butyl group. A particular phosphonate group disclosed herein is —CH₂P(O)(OH)₂.

The terms “phosphonate” and “phosphonic acid” can used interchangeably and are intended to encompass the same functional group since the two forms are dependent upon the prevailing alkalinity and acidity.

The term “phosphonated” as used herein refers to a molecule having at least one phosphonate or phosphonate group.

The present disclosure provides scale inhibitor compositions and methods for inhibiting scale comprising contacting an aqueous fluid with a scale inhibitor composition comprising at least one polyalkyl phosphonated polyol ether as described herein, in an amount effective to inhibit scale. The polyalkyl phosphonated polyol ethers are prepared by alkyl phosphonation of amines. In some aspects, the level of alkyl phosphonation of amines is deliberately controlled to provide partially substituted polyalkyl phosphonated polyol ethers, or mixtures of partially substituted and fully substituted polyalkyl phosphonated polyol ethers. In some aspects, polyalkyl phosphonated polyol ethers can exhibit facile biodegradation, when tested according to method OECD 306. For example, the polyalkyl phosphonated polyol ethers can have greater than 20, 30, 40, 50, or 60% biodegradation according to method OECD 306. For polyalkyl phosphonated polyol ethers having 20-60% biodegradation according to method OECD, the polyalkyl phosphonated polyol ethers can have EC₅₀ values of greater than 10 mg/L within the test period in accordance with ISO 10253. The polyalkyl phosphonated polyol ethers can also offer minimal toxicity to marine algae and are not expected to bioaccumulate.

In several aspects, the polyalkyl phosphonated polyol ether has a structure represented by Formula I:

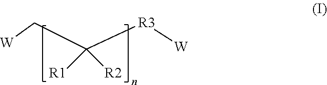

### In Formula I,

each W is —OH or

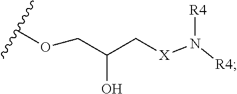

each R1 and R2 is independently selected from —H, —W, and —CH₂OH;
R3 is absent or —CH₂— and when R3 is absent, O is attached to C that is connected to R1 and R2;
each R4 is independently selected from —H, —CH₃, —CH₂CH₂OH, —CHZCO₂H, and —CH₂P(O)(OH)₂, wherein at least one R4 is —CH₂P(O)(OH)₂;
each X independently is absent or —NHCH₂CH₂— and when X is absent, N(R4)₂ is attached to C that is connected to X;
each Z independently is a side chain of an amino acid; and
n is an integer selected from 1, 2, 3, 4, 5, 6, 7 and 8. In Formula I, at least one W group is

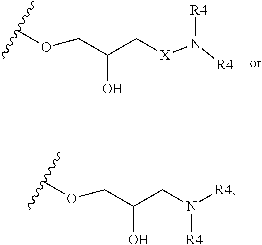

wherein each R4 is independently selected from —H, —CH₃, —CH₂CH₂OH, —CHZCO₂H, and —CH₂P(O)(OH)₂, and wherein at least one R4 is —CH₂P(O)(OH)₂.

In aspects where the polyalkyl phosphonated polyol ether has a Z group, each Z independently can be a group that is a side chain of an amino acid. In several aspects, the amino acid can be alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, or valine. In several aspects, each Z independently is a group that is a side chain of aspartic acid or glycine. In several aspects, each Z independently is —H, —CH₃, —CH(CH₃)₂, —CH₂CH(CH₃)₂, —C(CH₃)CH₂CH₃, —CH₂SH, —CH₂CH₂SCH₃, —CH₂(C₆H₅), —CH₂(C₈H₆N), —CH₂OH, —CH(OH)CH₃, —CH₂(C₆H₅O), —CH₂C(O)NH₂, —CH₂CH₂C(O)NH₂, —CH₂CO₂H, —CHCH₂CO₂H, —CH₂CH₂CH₂CH₂NH₂, —CH₂CH₂CH₂NHC(NH)NH₂, or —CH₂(C₃H₃N₂). In several aspects, each Z independently is —H or —CH₂CO₂H.

In aspects, the polyalkyl phosphonated polyol ether is

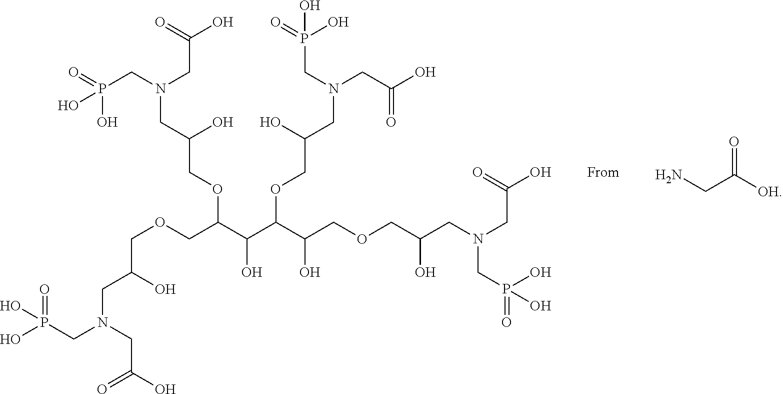 [SMILES: O=C(O)CN(CC(O)COCC(O)C(OCC(O)CN(CC(=O)O)CP(=O)(O)O)C(O)C(COCC(O)CN(CC(=O)O)CP(=O)(O)O)OCC(O)CN(CC(=O)O)CP(=O)(O)O)CP(=O)(O)O ; NCC(=O)O]

In aspects, the polyalkyl phosphonated polyol ether is

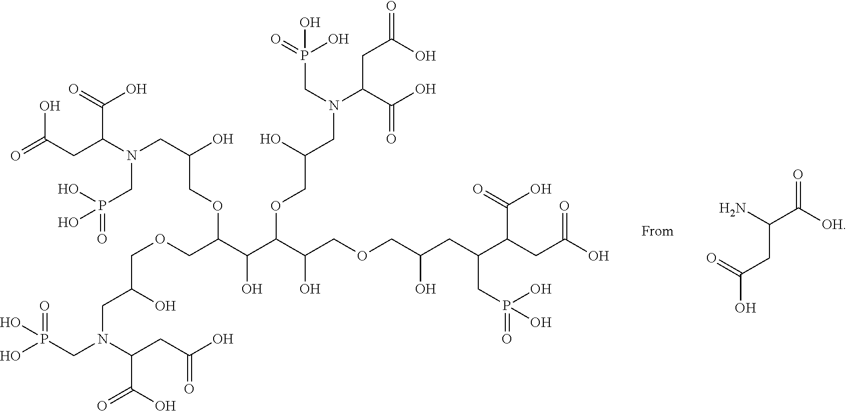 [SMILES: O=C(O)CC(C(=O)O)C(CC(O)COCC(O)C(OCC(O)CN(CP(=O)(O)O)C(CC(=O)O)C(=O)O)C(O)C(COCC(O)CN(CP(=O)(O)O)C(CC(=O)O)C(=O)O)OCC(O)CN(CP(=O)(O)O)C(CC(=O)O)C(=O)O)CP(=O)(O)O ; NC(CC(=O)O)C(=O)O]

In several aspects, the polyalkyl phosphonated polyol ether has a structure represented by Formula I and each R4 is —CH₂P(O)(OH)₂.

In several aspects, the polyalkyl phosphonated polyol ether has a structure represented by Formula II:

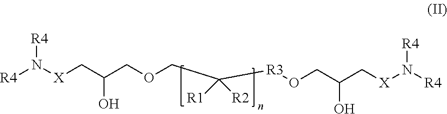

wherein,
each R1 and R2 is independently selected from —H, —OR5, and —CH₂OH;
R3 is absent or —CH₂— and when R3 is absent, O is attached to C that is connected to R1 and R2;
each R4 is independently selected from —H, —CH₃, —CH₂CH₂OH, —CHZCO₂H, and —CH₂P(O)(OH)₂, wherein at least one R4 is —CH₂P(O)(OH)₂;
each R5 is independently H or —CH₂CH(OH)CH₂N(R4)₂;
each X independently is absent or —NHCH₂CH₂— and when X is absent, N(R4)₂ is attached to C that is connected to X;
each Z independently is a side chain of an amino acid; and
n is an integer selected from 1, 2, 3, 4, 5, 6, 7 and 8.

In several aspects, n is 4, at least two R1 are —OR5, each R5 is —CH₂CH(OH)CH₂N(R4)₂, and at least one, two, three, four, five, six, seven, or eight R4 are —CH₂P(O)(OH)₂. In some aspects, at least six R4 are —CH₂P(O)(OH)₂. In some aspects, four R4 are —CH₂P(O)(OH)₂. In some aspects, five R4 are —CH₂P(O)(OH)₂. In some aspects, six R4 are —CH₂P(O)(OH)₂. In some aspects, seven R4 are —CH₂P(O)(OH)₂. In some aspects, eight R4 are —CH₂P(O)(OH)₂.

In several aspects, the polyalkyl phosphonated polyol ether has a structure represented by Formula IIa, IIb, or IIc:

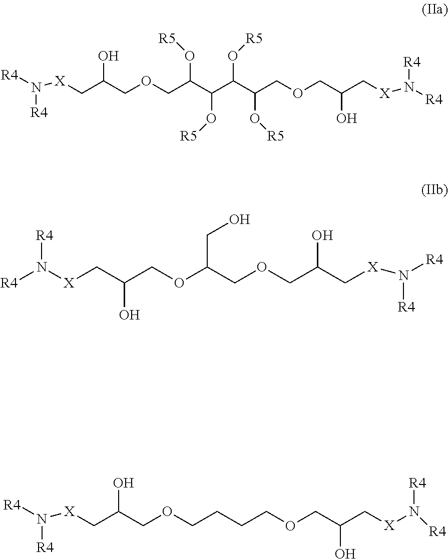

wherein,
each R4 is independently —H or —CH₂P(O)(OH)₂, wherein at least one R4 is —CH₂P(O)(OH)₂;
each R5 independently is H or —CH₂CH(OH)CH₂N(R4)₂; and
each X independently is absent or —NHCH₂CH₂— and when X is absent, (NR4)₂ is attached to C that is connected to X.

In several aspects, the polyalkyl phosphonated polyol ether has a structure represented by Formula IIa:

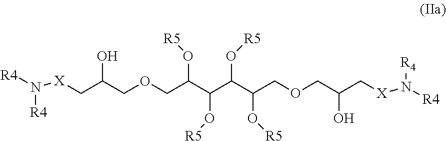

wherein
each R5 is H or —CH₂CH(OH)CH₂N(R4)₂ and at least four R4 are —CH₂P(O)(OH)₂.

In several aspects, the polyalkyl phosphonated polyol ether has a structure represented by Formula IIa, at least two R5 are —CH₂CH(OH)CH₂N(R4)₂ and at least one, two, three, four, five, six, seven, or eight R4 are —CH₂P(O)(OH)₂. In some aspects, at least six R4 are —CH₂P(O)(OH)₂. In some aspects, four R4 are —CH₂P(O)(OH)₂. In some aspects, five R4 are —CH₂P(O)(OH)₂. In some aspects, six R4 are —CH₂P(O)(OH)₂. In some aspects, seven R4 are —CH₂P(O)(OH)₂. In some aspects, eight R4 are —CH₂P(O)(OH)₂. In several aspects, each R4 is —CH₂P(O)(OH)₂.

In several aspects, the polyalkyl phosphonated polyol ether has a structure represented by Formula IIa1, IIa2, IIa3, IIa4, IIb1, or IIc1:

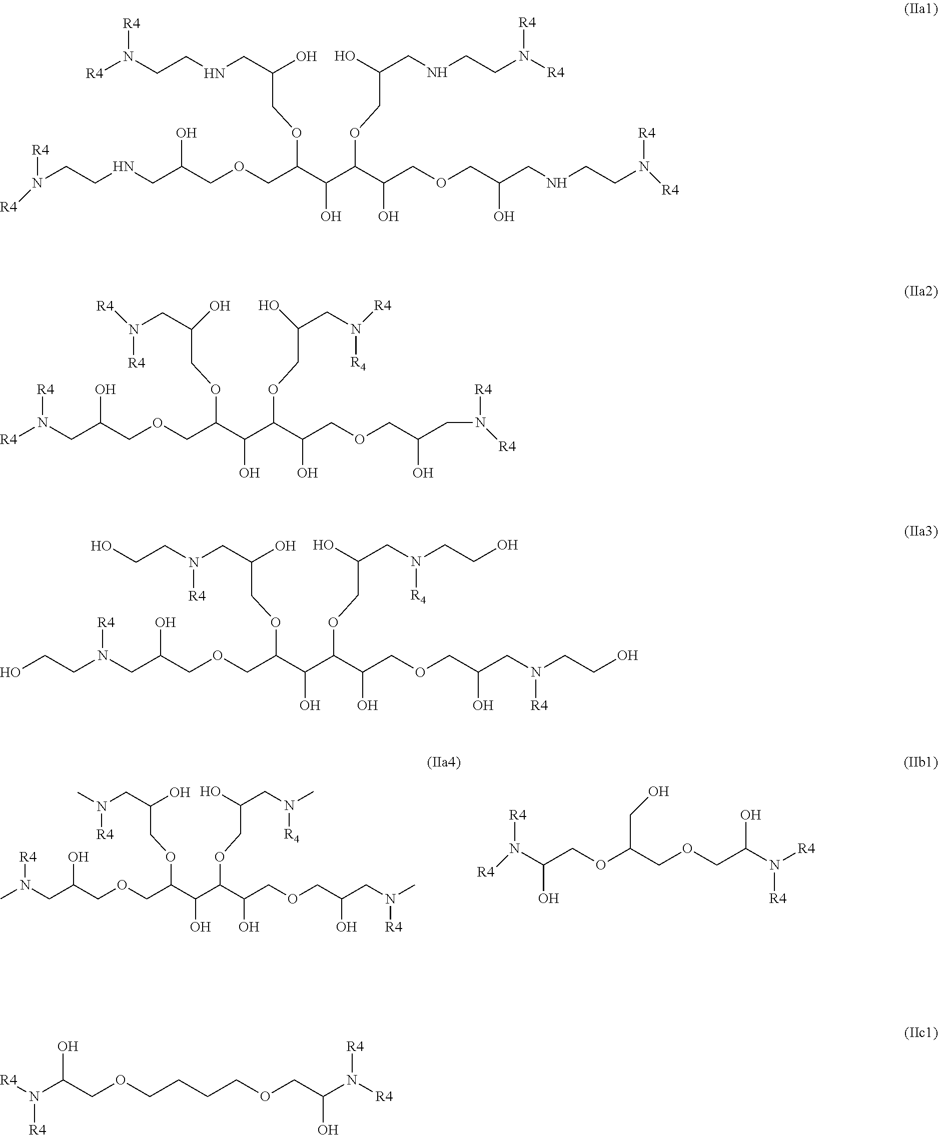

wherein,
each R4 is independently —H or —CH₂P(O)(OH)₂, wherein at least one R4 is —CH₂P(O)(OH)₂.

In several aspects, the polyalkyl phosphonated polyol ether has the structure represented by Formula IIa1 and at least one, two, three, four, five, six, seven, or eight R4 are —CH₂P(O)(OH)₂. In some aspects, at least four R4 are —CH₂P(O)(OH)₂. In some aspects, at least six R4 are —CH₂P(O)(OH)₂. In some aspects, four R4 are —CH₂P(O)(OH)₂. In some aspects, five R4 are —CH₂P(O)(OH)₂. In some aspects, six R4 are —CH₂P(O)(OH)₂. In some aspects, seven R4 are —CH₂P(O)(OH)₂. In some aspects, eight R4 are —CH₂P(O)(OH)₂. In several aspects, each R4 is —CH₂P(O)(OH)₂.

In several aspects, the polyalkyl phosphonated polyol ether has the structure represented by Formula IIa2 and at least one, two, three, four, five, six, seven, or eight R4 are —CH₂P(O)(OH)₂. In some aspects, at least four R4 are —CH₂P(O)(OH)₂. In some aspects, at least six R4 are —CH₂P(O)(OH)₂. In some aspects, four R4 are —CH₂P(O)(OH)₂. In some aspects, five R4 are —CH₂P(O)(OH)₂. In some aspects, six R4 are —CH₂P(O)(OH)₂. In some aspects, seven R4 are —CH₂P(O)(OH)₂. In some aspects, eight R4 are —CH₂P(O)(OH)₂. In several aspects, each R4 is —CH₂P(O)(OH)₂.

In several aspects, the polyalkyl phosphonated polyol ether has the structure represented by Formula IIa3 and at least one, two, three, or four R4 are —CH₂P(O)(OH)₂. In some aspects, one R4 is —CH₂P(O)(OH)₂. In some aspects, two R4 are —CH₂P(O)(OH)₂. In some aspects, three R4 are —CH₂P(O)(OH)₂. In some aspects, four R4 are —CH₂P(O)(OH)₂. In several aspects, each R4 is —CH₂P(O)(OH)₂.

In several aspects, the polyalkyl phosphonated polyol ether has the structure represented by Formula IIa4 and at least one, two, three, or four R4 are —CH₂P(O)(OH)₂. In some aspects, one R4 is —CH₂P(O)(OH)₂. In some aspects, two R4 are —CH₂P(O)(OH)₂. In some aspects, three R4 are —CH₂P(O)(OH)₂. In some aspects, four R4 are —CH₂P(O)(OH)₂. In several aspects, each R4 is —CH₂P(O)(OH)₂.

In several aspects, the polyalkyl phosphonated polyol ether has the structure represented by Formula IIb1 and at least one, two, three, or four R4 are —CH₂P(O)(OH)₂. In some aspects, one R4 is —CH₂P(O)(OH)₂. In some aspects, two R4 are —CH₂P(O)(OH)₂. In some aspects, three R4 are —CH₂P(O)(OH)₂. In some aspects, four R4 are —CH₂P(O)(OH)₂. In several aspects, each R4 is —CH₂P(O)(OH)₂.

In several aspects, the polyalkyl phosphonated polyol ether has the structure represented by Formula IIc1 and at least one, two, three, or four R4 are —CH₂P(O)(OH)₂. In some aspects, one R4 is —CH₂P(O)(OH)₂. In some aspects, two R4 are —CH₂P(O)(OH)₂. In some aspects, three R4 are —CH₂P(O)(OH)₂. In some aspects, four R4 are —CH₂P(O)(OH)₂. In several aspects, each R4 is —CH₂P(O)(OH)₂.

In several aspects, the polyalkyl phosphonated polyol ether comprises a polymethyl phosphonated polyol ether.

In several aspects, the polyalkyl phosphonated polyol ether comprises 1,3,5,6-tetrakis{3-[bis(phosphonomethyl)amino]-2-hydroxypropoxy}-2,4-hexandiol; 12,14-bis(3-((2-(bis(phosphonomethyl)amino)ethyl)amino)-2-hydroxypropoxy)-2,23-(bis(phosphonomethyl)amino)-9,16-dioxa-2,5,20,23-tetraazatetracosane-7,11,13,18-tetraol; 10,12-bis(2-hydroxy-3-((2-hydroxyethyl)(phosphonomethyl)amino)propoxy)-3,18-bis(phosphonomethyl)-7,14-dioxa-3,18-diazaicosane-1,5,9,11,16,20-hexaol; 9,11-bis(2-hydroxy-3-(methyl(bis(phosphonomethyl))amino)propoxy)-2,17-di(bis(phosphonomethyl)-6,13-dioxa-2,17-diazaoctadecane-4,8,10,15-tetraol; 3,3′-((3-hydroxypropane-1,2-diyl)bis(oxy))bis(1-(bis(phosphonomethyl)propan-2-ol); 3,3′-(butane-1,4-diylbis(oxy))bis(1-(bis(phosphonomethyl))propan-2-ol); or any combination thereof. In several aspects, the polyalkyl phosphonated polyol ether comprises 1,3,5,6-tetrakis{3-[bis(phosphonomethyl)amino]-2-hydroxypropoxy}-2,4-hexandiol. In several aspects, the polyalkyl phosphonated polyol ether comprises 12,14-bis(3-((2-(bis(phosphonomethyl)amino)ethyl)amino)-2-hydroxypropoxy)-2,23-(bis(phosphonomethyl)amino)-9,16-dioxa-2,5,20,23-tetraazatetracosane-7,11,13,18-tetraol. In several aspects, the polyalkyl phosphonated polyol ether comprises 10,12-bis(2-hydroxy-3-((2-hydroxyethyl)(phosphonomethyl)amino)propoxy)-3,18-bis(phosphonomethyl)-7,14-dioxa-3,18-diazaicosane-1,5,9,11,16,20-hexaol. In several aspects, the polyalkyl phosphonated polyol ether comprises 9,11-bis(2-hydroxy-3-(methyl(bis(phosphonomethyl))amino)propoxy)-2,17-di(bis(phosphonomethyl)-6,13-dioxa-2,17-diazaoctadecane-4,8,10,15-tetraol. In several aspects, the polyalkyl phosphonated polyol ether comprises 3,3′-((3-hydroxypropane-1,2-diyl)bis(oxy))bis(1-(bis(phosphonomethyl)propan-2-ol). In several aspects, the polyalkyl phosphonated polyol ether comprises 3,3′-(butane-1,4-diylbis(oxy))bis(1-(bis(phosphonomethyl))propan-2-ol).

In aspects, the scale inhibitor composition includes the polyalkyl phosphonated polyol ether in an amount of at least 10 wt %; alternatively, in an amount of at least 20 wt %; alternatively, in an amount of at least 30 wt %; alternatively, in an amount of at least 40 wt %; alternatively, in an amount of at least 50 wt %, based on a total weight of the scale inhibitor composition. In aspects, the scale inhibitor composition includes the polyalkyl phosphonated polyol ether in an amount of less than 90 wt %; alternatively, in an amount of less than 80 wt %; alternatively, in an amount of less than 70 wt %, based on a total weight of the scale inhibitor composition. In aspects, the scale inhibitor composition includes the polyalkyl phosphonated polyol ether in a range of about 10 wt % to about 90 wt %; alternatively, in a range of from about 10 wt % to about 80 wt %; alternatively, in a range of from about 10 wt % to about 70 wt %, based on a total weight of the scale inhibitor composition.

In several aspects, a concentration of the at least one polyalkyl phosphonated polyol ether is in a range of from about 1 ppmw to about 10,000 ppmw based on a total weight of the aqueous fluid. In several aspects, a concentration of the at least one polyalkyl phosphonated polyol ether is in a range of from about 1 ppmw to about 1,000 ppmw based on a total weight of the aqueous fluid. In several aspects, a concentration of the at least one polyalkyl phosphonated polyol ether is in a range of from about 1 ppmw to about 100 ppmw based on a total weight of the aqueous fluid. In several aspects, a concentration of the at least one polyalkyl phosphonated polyol ether is in a range of from about 1 ppmw to about 50 ppmw based on a total weight of the aqueous fluid.

### Additional Components

Additional components for inclusion in the scale inhibitor compositions include corrosion inhibitors, solvents, asphaltene inhibitors, paraffin inhibitors, emulsifiers, water clarifiers, dispersants, emulsion breakers, hydrogen sulfide scavengers, gas hydrate inhibitors, biocides, pH modifiers, surfactants, functional agents and other additives, or combinations thereof.

### Corrosion Inhibitors

The scale inhibitor composition can additionally include one or more corrosion inhibitors. Corrosion inhibitors can include a quaternary ammonium compound, an imidazoline derivative, an organic sulfur compound, or combinations thereof. Quaternary ammonium compounds can include tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, trialkyl benzyl quaternary ammonium compounds, or combinations thereof. Imidazoline derivatives can be selected from an imidazoline derived from a polyamine and a long chain fatty acid. Examples of the polyamine can include ethylene diamine (EDA), diethylene triamine (DETA), triethylene tetraamine (TETA), or combinations thereof. Organic sulfur compounds can include a thiol (also known as a mercaptan), an organic disulfide, or combinations thereof.

### Solvents

The scale inhibitor composition can further include one or more solvents. Examples of solvents include, but are not limited to, water, alcohols, hydrocarbons, ketones, ethers, aromatics, amides, nitriles, sulfoxides, esters, glycol ethers, aqueous systems, and combinations thereof. In certain embodiments, the solvent is water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or combinations thereof. Representative polar solvents suitable for formulation with the composition include water, brine, seawater, alcohols (including straight chain or branched aliphatic such as methanol, ethanol, propanol, isopropanol, butanol, 2-ethylhexanol, hexanol, octanol, decanol, 2-butoxyethanol, etc.), glycols and derivatives (ethylene glycol, 1,2-propylene glycol, 1,3-propylene glycol, ethylene glycol monobutyl ether, etc.), ketones (cyclohexanone, diisobutylketone), N-methylpyrrolidinone (NMP), N,N-dimethylformamide, or combinations thereof. Representative non-polar solvents suitable for formulation with the composition include aliphatic hydrocarbons such as pentane, hexane, cyclohexane, methylcyclohexane, heptane, decane, dodecane, diesel, or combinations thereof; aromatic hydrocarbons such as toluene, xylene, heavy aromatic naphtha, fatty acid derivatives (acids, esters, amides), or combinations thereof; or any combination of aliphatic hydrocarbons and aromatic hydrocarbons.

### Asphaltene Inhibitors

The scale inhibitor composition can additionally include an asphaltene inhibitor. Examples of asphaltene inhibitors include, but are not limited to, aliphatic sulphonic acids; alkyl aryl sulphonic acids; aryl sulfonates; lignosulfonates; alkylphenol/aldehyde resins and similar sulfonated resins; polyolefin esters; polyolefin imides; polyolefin esters with alkyl, alkylenephenyl or alkylenepyridyl functional groups; polyolefin amides; polyolefin amides with alkyl, alkylenephenyl or alkylenepyridyl functional groups; polyolefin imides with alkyl, alkylenephenyl or alkylenepyridyl functional groups; alkenyl/vinyl pyrrolidone copolymers; graft polymers of polyolefins with maleic anhydride or vinyl imidazole; hyperbranched polyester amides; polyalkoxylated asphaltenes, amphoteric fatty acids; salts of alkyl succinates; sorbitan monooleate; and polyisobutylene succinic anhydride, or combinations thereof.

### Paraffin Inhibitors

The scale inhibitor composition disclosed herein can additionally include one or more paraffin inhibitors. Examples of paraffin inhibitors include, but are not limited to, paraffin crystal modifiers, and dispersant/crystal modifier combinations. Examples of paraffin crystal modifiers include, but are not limited to, alkyl acrylate copolymers, alkyl acrylate vinylpyridine copolymers, ethylene vinyl acetate copolymers, maleic anhydride ester copolymers, branched polyethylenes, naphthalene, anthracene, microcrystalline wax, asphaltenes, or combinations thereof. Examples of dispersants include, but are not limited to, dodecyl benzene sulfonate, oxyalkylated alkylphenols, and oxyalkylated alkylpnenolic resins, or combinations thereof.

### Biocides

The scale inhibitor composition can additionally include one or more biocides.

Examples of biocides include, but are not limited to, oxidizing and non-oxidizing biocides. Examples of non-oxidizing biocides include, for example, aldehydes (e.g., formaldehyde, glutaraldehyde, acrolein, or combinations thereof), amine-type compounds (e.g., quaternary amine compounds, cocodiamine, or a combination thereof), halogenated compounds (e.g., bronopol, 2-2-dibromo-3-nitrilopropionamide (DBNPA), or a combination thereof), sulfur compounds (e.g., isothiazolone, carbamates, metronidazole, or a combination thereof), quaternary phosphonium salts (e.g., tetrakis(hydroxymethyl)phosphonium sulfate (THPS)), or combinations thereof.

Examples of oxidizing biocides include sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, peroxides, or combinations thereof.

### Emulsifiers

The scale inhibitor composition disclosed herein can additionally include one or more emulsifier. Examples of emulsifiers include, but are not limited to, salts of carboxylic acids, products of acylation reactions between carboxylic acids or carboxylic anhydrides and amines, alkyl-, acyl-, and amide derivatives of saccharides (alkyl-saccharide emulsifiers), or combinations thereof.

### Water Clarifiers

The scale inhibitor composition disclosed herein can include one or more water clarifiers. Examples of water clarifiers include, but are not limited to, inorganic metal salts such as alum, aluminum chloride, and aluminum chlorohydrate; organic polymers such as acrylic acid based polymers; acrylamide based polymers; polymerized amines; alkanolamines; thiocarbamates; cationic polymers such as diallyldimethylammonium chloride (DADMAC); or combinations thereof.

### Dispersants

The scale inhibitor composition can additionally include one or more dispersants. Examples of dispersants include, but are not limited to, aliphatic phosphonic acids with 2 to 50 carbon atoms (e.g., hydroxyethyl diphosphonic acid), aminoalkyl phosphonic acids (e.g., polyaminomethylene phosphonates with 2 to 10 N atoms, for example, each bearing at least one methylene phosphonic acid group), or combinations thereof. Examples of polyaminomethylene phosphonates are ethylenediamine tetra(methylene phosphonate), diethylenetriamine penta(methylene phosphonate), triamine- and tetramine-polymethylene phosphonates with 2-4 methylene groups between each N atom, at least 2 of the numbers of methylene groups in each phosphonate being different, or combinations thereof. Other dispersants can include lignin or derivatives of lignin such as lignosulfonate and naphthalene sulfonic acid and derivatives.

### Emulsion Breakers

The scale inhibitor composition can additionally include one or more emulsion breakers. Examples of emulsion breakers include, but are not limited to, dodecylbenzylsulfonic acid (DDBSA), the sodium salt of xylenesulfonic acid (NAXSA), epoxylated and propoxylated compounds, anionic cationic and nonionic surfactants, resins such as phenolic resins and epoxide resins, or combinations thereof.

### Hydrogen Sulfide Scavengers

The scale inhibitor composition can additionally include one or more hydrogen sulfide scavengers. Examples of additional hydrogen sulfide scavengers include, but are not limited to, oxidants (e.g., inorganic peroxides such as sodium peroxide, or chlorine dioxide), aldehydes (e.g., of 1 to 10 carbon atoms such as formaldehyde or glutaraldehyde or (meth)acrolein), triazines (e.g., monoethanol amine triazine, monomethylamine triazine, and triazines from multiple amines or mixtures thereof), glyoxal, or combinations thereof.

### Gas Hydrate Inhibitors

The scale inhibitor composition can additionally include one or more gas hydrate inhibitors. Examples of gas hydrate inhibitors include, but are not limited to, thermodynamic hydrate inhibitors (THI), kinetic hydrate inhibitors (KHI), anti-agglomerates (AA), or combinations thereof.

Examples of thermodynamic hydrate inhibitors include, but are not limited to, NaCl salt, KCl salt, CaCl₂ salt, MgCl₂ salt, NaBr₂ salt, formate brines (e.g. potassium formate), polyols (e.g., glucose, sucrose, fructose, maltose, lactose, gluconate, monoethylene glycol, diethylene glycol, triethylene glycol, mono-propylene glycol, dipropylene glycol, tripropylene glycols, tetrapropylene glycol, monobutylene glycol, dibutylene glycol, tributylene glycol, glycerol, diglycerol, triglycerol, sugar alcohols (e.g. sorbitol, mannitol), or combinations thereof), methanol, propanol, ethanol, glycol ethers (e.g., diethyleneglycol monomethylether, ethyleneglycol monobutylether, or combinations thereof), alkyl or cyclic esters of alcohols (e.g., ethyl lactate, butyl lactate, methylethyl benzoate, or combinations thereof), or combinations thereof.

Examples of kinetic hydrate inhibitors and anti-agglomerates include, but are not limited to, polymers and copolymers, polysaccharides (e.g., hydroxy-ethylcellulose (HEC), carboxymethylcellulose (CMC), starch, starch derivatives, xanthan, or combinations thereof), lactams (e.g., polyvinylcaprolactam, polyvinyl lactam), pyrrolidones (e.g., polyvinyl pyrrolidone of various molecular weights), surfactants (e.g., fatty acid salts, ethoxylated alcohols, propoxylated alcohols, sorbitan esters, ethoxylated sorbitan esters, polyglycerol esters of fatty acids, alkyl glucosides, alkyl polyglucosides, alkyl sulfates, alkyl sulfonates, alkyl ester sulfonates, alkyl aromatic sulfonates, alkyl betaine, alkyl amido betaines, or combinations thereof), hydrocarbon based dispersants (e.g., lignosulfonates, iminodisuccinates, polyaspartates, or combinations thereof), amino acids, proteins, or combinations thereof.

### pH Modifiers

The scale inhibitor composition can additionally include one or more pH modifiers. Examples of pH modifiers include, but are not limited to, alkali hydroxides, alkali carbonates, alkali bicarbonates, alkaline earth metal hydroxides, alkaline earth metal carbonates, alkaline earth metal bicarbonates, or combinations thereof. Exemplary pH modifiers include NaOH, KOH, Ca(OH)₂, CaO, Na₂CO₃, KHCO₃, K₂CO₃, NaHCO₃, MgO, and Mg(OH)₂, or combinations thereof.

### Surfactants

The scale inhibitor composition can additionally include one or more surfactants. Examples of surfactants include, but are not limited to, anionic surfactants, cationic surfactants, zwitterionic surfactants, and nonionic surfactants.

Anionic surfactants include alkyl aryl sulfonates, olefin sulfonates, paraffin sulfonates, alcohol sulfates, alcohol ether sulfates, alkyl carboxylates, alkyl ether carboxylates, alkyl phosphate esters, ethoxylated alkyl phosphate esters, and mono- and di-alkyl sulfosuccinates, mono- and di-alkyl sulfosuccinamates, or combinations thereof.

Cationic surfactants include alkyl trimethyl quaternary ammonium salts, alkyl dimethyl benzyl quaternary ammonium salts, dialkyl dimethyl quaternary ammonium salts, imidazolinium salts, or combinations thereof.

Nonionic surfactants include alcohol alkoxylates, alkylphenol alkoxylates, block copolymers of ethylene, propylene and butylene oxides, alkyl dimethyl amine oxides, alkyl-bis(2-hydroxyethyl) amine oxides, alkyl amidopropyl dimethyl amine oxides, alkylamidopropyl-bis(2-hydroxyethyl) amine oxides, alkyl polyglucosides, polyalkoxylated glycerides, sorbitan esters and polyalkoxylated sorbitan esters, alkyl polyethylene glycol esters and diesters, or combinations thereof. Examples of nonionic surfactants also include betaines, sultanes, amphoteric surfactants (e.g., alkyl amphoacetates and amphodiacetates, alkyl amphopropripionates and amphodipropionates, alkyliminodiproprionate, or combinations thereof), or combinations thereof.

In some aspect, a surfactant may be a quaternary ammonium compound, an amine oxide, an ionic or non-ionic surfactant, or any combination thereof. Suitable quaternary amine compounds include, but are not limited to, alkyl benzyl ammonium chloride, benzyl cocoalkyl(C₁₂-C₁₈)dimethylammonium chloride, dicocoalkyl (C₁₂-C₁₈)dimethylammonium chloride, ditallow dimethylammonium chloride, di(hydrogenated tallow alkyl)dimethyl quaternary ammonium methyl chloride, methyl bis(2-hydroxyethyl cocoalkyl(C₁₂-C₁₈) quaternary ammonium chloride, dimethyl(2-ethyl) tallow ammonium methyl sulfate, n-dodecylbenzyldimethylammonium chloride, n-octadecylbenzyldimethyl ammonium chloride, n-dodecyltrimethylammonium sulfate, soya alkyltrimethylammonium chloride, and hydrogenated tallow alkyl (2-ethylhyexyl) dimethyl quaternary ammonium methyl sulfate.

### Functional Agents and Other Additives

Scale inhibitor compositions may further include additional functional agents or additives that provide a beneficial property. For example, additional agents or additives may be selected from pH adjusters or other neutralizing agents, surfactants, emulsifiers, sequestrants, solubilizers, other lubricants, buffers, detergents, cleaning agent, rinse aid composition, preservatives, binders, thickeners or other viscosity modifiers, processing aids, carriers, water-conditioning agents, foam inhibitors or foam generators, threshold agent or system, aesthetic enhancing agent (i.e., dye, odorant, perfume), other agents or additives suitable for formulation with a scale inhibitor composition and the like, and mixtures thereof. Additional agents or additives will vary according to the particular scale inhibitor composition being manufactured.

The scale inhibitor compositions made may further include additional functional agents or additives that provide a beneficial property. Additional agents or additives will vary according to the particular composition being manufactured and its intended use as one skilled in the art will appreciate. According to one embodiment, the compositions do not contain any of the additional agents or additives.

### Concentration of Additional Components

A scale inhibitor composition described herein may comprise from 0 wt % to 80 wt %, 0 wt % to 60 wt %, or 0 wt % to 50 wt % of one or more additional components, based on total weight of the composition. In some aspects, a scale inhibitor composition disclosed herein can have at least 1.0 wt %, 1.5 wt %, 2.0 wt %, 2.5 wt %, 3.0 wt %, 3.5 wt %, 4.0 wt %, 4.5 wt %, 5.0 wt %, 5.5 wt %, 6.0 wt %, 6.5 wt %, 7.0 wt %, 7.5 wt %, 8.0 wt %, 8.5 wt %, 9.0 wt %, 9.5 wt %, 10.0 wt %, 10.5 wt %, 11.0 wt %, 11.5 wt %, 12.0 wt %, 12.5 wt %, 13.0 wt %, 13.5 wt %, 14.0 wt %, 14.5 wt %, or 15.0 wt % of one or more additional components, based on total weight of the composition; and less than 80, 79, 78, 77, 76, 75, 74, 73, 72, 71, 70, 69, 68, 67, 66, 65, 64, 63, 62, 61, or 60 wt % of the one or more additional components based on total weight of the composition.

### Methods

Method disclosed herein include preparing the polyalkyl phosphonated polyol ethers described herein. Preparing the polyalkyl phosphonated polyol ethers described herein can include reacting an amine with hydrochloric acid, phosphorous acid, and an aldehyde. In aspects where it is desired to form partially substituted polyalkyl phosphonated polyol ethers as the major product, the stoichiometric ratios of the reactants can be controlled. The amine that reacts with phosphorous acid, etc. can be produced by the reaction of another amine with a polyglycidyl ether. In some aspects, the other amine is selected from ammonia, methyl amine, ethanol amine, and ethylene diamine.

Methods for inhibiting scale as disclosed herein can be used in various applications, including but not limited to, hydrocarbon (e.g., oilfield) streams, industrial water treatment, laundry systems, detergents, industrial cleaning, residential cleaning, and medical applications.

In aspects, a method for inhibiting scale can include contacting an aqueous fluid with a scale inhibitor composition comprising at least one polyalkyl phosphonated polyol ether as described herein, in an amount effective to inhibit scale. In several aspects, the scale inhibitor composition includes a mixture of polyalkyl phosphonated polyol ethers as described herein.

In additional or alternative aspects, the method for inhibiting scale can include introducing, adding, or injecting the scale inhibitor composition to the aqueous fluid. In several aspects, an effective scale inhibiting amount of the polyalkyl phosphonated polyol ether is introduced, added, or injected to the aqueous fluid. In aspects, the scale inhibitor composition can be added to equipment in a boiler water system, a hydrocarbon production system, or other system.

Another method for inhibiting scale can include transporting, moving, or circulating a fluid comprising the scale inhibitor composition in an oil and gas pipeline, in one or more hydrocarbon streams (e.g., a production stream, a refinery stream), in equipment configured for industrial water treatment, in equipment configured for residential water treatment, in laundry systems, or combinations thereof. The fluid can comprise water and be referred to as an aqueous fluid. In some aspects, the fluid can further include a hydrocarbon(s) (e.g., in gas phase, in liquid phase, or both in liquid phase and gas phase). For aqueous fluids, water can be present in a boiler water; in fresh, dirty, or recycled laundry water; in a brine; in water used in a medical application; in an industrial water source, or combinations thereof. Liquid hydrocarbons in the fluid can include, but are not limited to, crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. Gaseous hydrocarbons in the fluid can include, but are not limited to methane, ethane, propane, butane, or combinations thereof.

In several aspects, the method for inhibiting scale includes introducing, adding, or injecting the scale inhibitor composition comprising at least one polyalkyl phosphonated polyol ether as described herein into a subterranean formation via a wellbore. The scale inhibitor composition can be introduced, added, or injected can occur continuously, in a batch or dose or pill or slug, or periodically in a batch or dose or pill or slug. In some aspects, the scale inhibitor composition can be added to an injection fluid at the surface prior to being transported to the subterranean formation via the wellbore.

In several aspects, the method for inhibiting scale includes introducing, adding, or injecting the scale inhibitor composition comprising at least one polyalkyl phosphonated polyol ether as described herein to a produced fluid. In aspects, the introducing, adding, or injecting can occur in a wellbore, and the method can further include flowing a wellbore fluid comprising the produced fluid and the scale inhibitor composition to the surface via the wellbore. In additional aspects, the introducing, adding, or injecting can occur continuously, in a batch, or periodically in a batch. A batch can also be referred to as or a dose, a pill, or a slug of fluid containing the scale inhibitor composition.

In several aspects, the method for inhibiting scale includes introducing, adding, or injecting the scale inhibitor composition comprising at least one polyalkyl phosphonated polyol ether as described herein to a produced fluid, where the introducing, adding, or injecting can occur downstream of the wellbore (e.g., in a production conduit). In aspects, the method can further include flowing a fluid comprising the produced fluid and the scale inhibitor composition to a processing system or storage. In additional aspects, the introducing, adding, or injecting can occur continuously, in a batch, or periodically in a batch. A batch can also be referred to as or a dose, a pill, or a slug of fluid containing the scale inhibitor composition.

In several aspects, the method for inhibiting scale includes, prior to introducing the scale inhibitor composition into a subterranean formation via a wellbore, stopping production of a production fluid from the wellbore. The production fluid can include one or more hydrocarbons, water (e.g., contained in a brine), or both water. In aspects, the production fluid can include hydrocarbons in gas phase, hydrocarbons in liquid phase, or both hydrocarbons in liquid phase and in gas phase. In further aspects, the production fluid can include solids, such as pieces of the subterranean formation or sand.

In several aspects, the method for inhibiting scale includes producing a production fluid from a subterranean formation via a production wellbore. In several aspects, the method includes introducing the scale inhibitor composition into the subterranean formation via an injection wellbore or into the production fluid in the production wellbore, optionally while the production fluid is flowing in the production.

In several aspects, the method for inhibiting scale includes receiving a production fluid from a wellbore. In several aspects, the method includes introducing the scale inhibitor composition into the production fluid.

### EXAMPLES

The following Examples describe the methods and conditions used to prepare polyalkyl phosphonated polyol ethers, analyze the reaction products, and test the reaction products for scale inhibition, biodegradation, toxicity, and bioaccumulation. The specific examples described below are used to be illustrative, and not intended to restrict the broader scope of the disclosure.

Example 1: Preparation of 1,3,5,6-Tetrakis{3-[bis(phosphonomethyl)amino]-2-hydroxypropoxy}-2,4-hexandiol. To a multi-neck flask equipped with a mechanical stirrer, a reflux condenser, a thermoprobe connected to a temperature controller and inlet for nitrogen purge, sorbitol glycidyl ether, ammonium hydroxide (30%, excess) and methanol was charged. The reaction mixture was then heated to 35° C., purged with nitrogen under good agitation, and stirred continuously for 2 hours. The temperature of the reaction mixture was increased to 70° C. with continuous stirring for 2 hours and then raised to 95° C. and the reaction mixture was stirred continuously for 3 hours. The intermediate product 1,3,5,6-tetrakis(3-amino-2-hydroxypropoxy)-2,4-hexandiol was transferred to a multi-neck flask equipped with a mechanical stirrer, a reflux condenser, a thermoprobe connected to a temperature controller and inlet for nitrogen purge. Aqueous phosphorous acid (70%) followed by a solution of hydrochloric acid (HCl) were added to the reaction flask under good agitation and nitrogen purge along with deionized water. The reaction mixture was then heated to 93° C. and solid paraformaldehyde (91%) was added in equal-weighted portions over a period of time to limit excess heating. Once the addition of paraformaldehyde was complete, the reaction mixture was heated to 110° C. and allowed to reflux for 3 hours. The reaction mixture was then cooled to room temperature and partially neutralized by 50% NaOH solution to pH 1-2.

Example 2: Preparation of 12,14-bis(3-((2-(bis(phosphonomethyl)amino)ethyl)amino)-2-hydroxypropoxy)-2,23-(bis(phosphonomethyl)amino)-9,16-dioxa-2,5,20,23-tetraazatetracosane-7,11,13,18-tetraol. The procedure of Example 1 was repeated using a solution of ethylene diamine in methanol in place of aqueous ammonium hydroxide.

Example 3: Preparation of 10,12-bis(2-hydroxy-3-((2-hydroxyethyl)(phosphonomethyl)amino)propoxy)-3,18-bis(phosphonomethyl)-7,14-dioxa-3,18-diazaicosane-1,5,9,11,16,20-hexaol. The procedure of Example 1 was repeated using a solution of ethanol amine in methanol in place of aqueous ammonium hydroxide.

Example 4: Preparation of 9,11-bis(2-hydroxy-3-(methyl(bis(phosphonomethyl))amino)propoxy)-2,17-di(bis(phosphonomethyl)-6,13-dioxa-2,17-diazaoctadecane-4,8,10,15-tetraol. The procedure of Example 1 was repeated using methylamine in place of ammonium hydroxide.

Example 5: Preparation of 3,3′-((3-hydroxypropane-1,2-diyl)bis(oxy))bis(1-(bis(phosphonomethyl)propan-2-ol). The procedure of Example 1 was repeated using glycerol diglycidyl ether in place of sorbitol glycidyl ether.

Example 6: Preparation of 3,3-(butane-1,4-diylbis(oxy))bis(1-(bis(phosphonomethyl))propan-2-ol). The procedure of Example 1 was repeated using 1,4-butanediol diglycidyl ether in place of sorbitol glycidyl ether.

Example 7: The static efficiency test was used to evaluate the inhibition efficiency of sulfate scale (e.g., BaSO₄ and SrSO₄) precipitation. Anion brine and cation brines A, B, C, and D were prepared according to Table 1. The preheated anion brine and cation brine were mixed at 1:1 (v/v) ratio to achieve the targeted concentration. Briefly. In the blank test, no scale inhibitor (SI) was added, but a known amount of various SI was added to other test bottles to understand the performance of various SIs. In the scale inhibition tests, inhibition performance or inhibition efficiency at 90° C., especially for barite inhibition at one hour after mixing of anion and cation brine with and without presence of SI was determined using the following equation:

$$Efficiency ( \% ) = [ 100 * ( {C}_{a} - {C}_{b} ) ] / [ {C}_{0} - {C}_{b} ]$$

At where:
Cₐ is the concentration (mg/L) of Ba²⁺ in solution after the one-hour test with scale inhibitor.
C_{b} is the concentration (mg/L) of Ba²⁺ in solution in the blank after the one-hour test (without scale inhibitor).
Cₒ is the concentration (mg/L) of the resulting Ba²⁺ in synthetic water.

TABLE 1

| | Brine A | Brine B | Brine C | Brine D |
|---|---|---|---|---|
| Na | 29236.5 | 21082.5 | 15759 | 13595 |
| K | 634.6 | 557 | 525.7 | 496.5 |
| Ca | 4577 | 2733 | 1240.7 | 879.5 |
| Mg | 801.9 | 1053.5 | 327.6 | 790 |
| Sr | 693.9 | 385.5 | 84.6 | 47 |
| Ba | 242.1 | 134.5 | 58.5 | 32.5 |
| Cl | 56739.8 | 40307 | 27466.4 | 24044 |
| SO₄ | 296 | 1480 | 296 | 1480 |

Example 8: Table 2 summarizes the static efficiency test results of the SIs prepared in Examples 1-6 using the DTPMP benchmark performed at 90° C. The SI dosages in Brine A, B, C and 0 was 1, 7.5, 5, and 30 ppm, respectively.

TABLE 2

| Scale | | | | |
|---|---|---|---|---|
| Inhibitor | Brine A | Brine B | Brine C | Brine D |
| DTPMP | 94% | 77% | 100% | 24% |
| Example 1 | 57% | 88% | 67% | 42% |
| Example 2 | 100% | 100% | 84% | 83% |
| Example 3 | 48% | 36% | 71% | 5% |
| Example 4 | 23% | 7% | 5% | 2% |
| Example 5 | 42% | 86% | 86% | 42% |
| Example 6 | 47% | 63% | 98% | 6% |

### Additional Description

Aspect 1. A method of inhibiting scale, comprising: contacting an aqueous fluid with a scale inhibitor composition comprising at least one polyalkyl phosphonated polyol ether.

Aspect 2. The method of Aspect 1, wherein the at least one polyalkyl phosphonated polyol ether has a structure represented by Formula I as disclosed herein, wherein, each W is —OH or

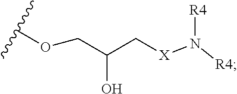

each R1 and R2 is independently selected from —H, —W, and —CH₂OH; R3 is absent or —CH₂— and when R3 is absent, O is attached to C that is connected to R1 and R2; each R4 is independently selected from —H, —CH₃, —CH₂CH₂OH, —CHZCO₂H, and —CH₂P(O)(OH)₂, wherein at least one R4 is —CH₂P(O)(OH)₂; each X independently is absent or —NHCH₂CH₂— and when X is absent, N(R4)₂ is attached to C that is connected to X; each Z independently is a side chain of an amino acid; and n is an integer selected from 1, 2, 3, 4, 5, 6, 7 and 8.

Aspect 3. The method of one of Aspect 1 or 2, wherein the at least one polyalkyl phosphonated polyol ether has a structure represented by Formula II as disclosed herein, wherein, each R1 and R2 is independently selected from —H, —OR5, and —CH₂OH; R3 is absent or —CH₂— and when R3 is absent, O is attached to C that is connected to R1 and R2; each R4 is independently selected from —H, —CH₃, —CH₂CH₂OH, —CHZCO₂H, and —CH₂P(O)(OH)₂, wherein at least one R4 is —CH₂P(O)(OH)₂; each R5 is independently H or —CH₂CH(OH)CH₂N(R4)₂; each X independently is absent or —NHCH₂CH₂— and when X is absent, N(R4)₂ is attached to C that is connected to X; each Z independently is a side chain of an amino acid; and n is an integer selected from 1, 2, 3, 4, 5, 6, 7 and 8.

Aspect 4. The method of Aspect 3, wherein n is 4, at least two R1 are —OR5, each R5 is —CH₂CH(OH)CH₂N(R4)₂, and at least four R4 are —CH₂P(O)(OH)₂.

Aspect 5. The method of one of Aspect 3 or 4, wherein at least six R4 are —CH₂P(O)(OH)₂.

Aspect 6. The method of any one of Aspects 1 to 5, wherein the at least one polyalkyl phosphonated polyol ether has a structure represented by Formula IIa, IIb, or IIc as disclosed herein, wherein, each R4 is independently —H or —CH₂P(O)(OH)₂, wherein at least one R4 is —CH₂P(O)(OH)₂; each R5 independently is H or —CH₂CH(OH)CH₂N(R4)₂; and each X independently is absent or —NHCH₂CH₂— and when X is absent, (NR4)₂ is attached to C that is connected to X.

Aspect 7. The method of Aspect 6, wherein the at least one polyalkyl phosphonated polyol ether has a structure represented by Formula IIa, wherein each R5 is H or —CH₂CH(OH)CH₂N(R4)₂ and at least four R4 are —CH₂P(O)(OH)₂.

Aspect 8. The method of Aspect 7, wherein at least six R4 are —CH₂P(O)(OH)₂.

Aspect 9. The method of Aspect 7, wherein each R4 is —CH₂P(O)(OH)₂.

Aspect 10. The method of any one of Aspects 1 to 9, wherein the at least one polyalkyl phosphonated polyol ether has a structure represented by Formula IIa1, IIa2, IIa3, IIa4, IIb1, or IIc1 as disclosed herein, wherein, each R4 is independently —H or —CH₂P(O)(OH)₂, wherein at least one R4 is —CH₂P(O)(OH)₂.

Aspect 11. The method of Aspect 10, wherein the at least one polyalkyl phosphonated polyol ether has the structure represented by Formula IIa1 or Formula IIa2 and at least 4 of R4 are —CH₂P(O)(OH)₂.

Aspect 12. The method of Aspect 11, wherein each R4 is —CH₂P(O)(OH)₂.

Aspect 13. The method of Aspect 10, wherein the at least one polyalkyl phosphonated polyol ether has the structure represented by Formula IIa1, IIa2, IIa3, IIa4, IIb1, or IIc1 and at least 2 R4 are —CH₂P(O)(OH)₂.

Aspect 14. The method of Aspect 13, wherein each R4 is —CH₂P(O)(OH)₂.

Aspect 15. The method of Aspect 10, wherein the scale inhibitor composition includes greater than 20 wt % polyalkyl phosphonated polyol ether having structure represented by Formula IIa1 or IIa2 and at least 4 of R4 are —CH₂P(O)(OH)₂.

Aspect 16. The method of any one of Aspects 1 to 15, wherein a concentration of the at least one polyalkyl phosphonated polyol ether is in a range of from about 1 ppmw to about 10,000 ppmw, alternatively from about 1 ppmw to about 1,000 ppmw, alternatively from about 1 ppmw to about 100 ppmw, alternatively from about 1 ppmw to about 50 ppmw, based on a total weight of the aqueous fluid.

Aspect 17. The method of any one of Aspects 1 to 16, further comprising: introducing the scale inhibitor composition into a subterranean formation via a wellbore.

Aspect 18. The method of Aspect 17, further comprising: prior to introducing the scale inhibitor composition into a subterranean formation via a wellbore, stopping production of a production fluid from the wellbore.

Aspect 19. The method of any one of Aspects 1 to 18, further comprising: producing a production fluid from a subterranean formation via a production wellbore; and introducing the scale inhibitor composition into the subterranean formation via an injection wellbore or into the production fluid in the production wellbore, optionally while the production fluid is flowing in the production.

Aspect 20. The method of any one of Aspects 1 to 19, further comprising: receiving a production fluid from a wellbore; and introducing the scale inhibitor composition into the production fluid.

Aspect 21. A scale inhibitor composition comprising a polyalkyl phosphonated polyol ether having a structure represented by Formula I as disclosed herein, wherein, each W is —OH or

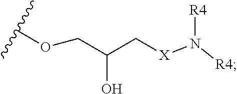

each R1 and R2 is independently selected from —H, —W, and —CH₂OH; R3 is absent or —CH₂— and when R3 is absent, O is attached to C that is connected to R1 and R2; each R4 is independently selected from —H, —CH₃, —CH₂CH₂OH, —CHZCO₂H, and —CH₂P(O)(OH)₂, wherein at least one R4 is —CH₂P(O)(OH)₂; each X independently is absent or —NHCH₂CH₂— and when X is absent, N(R4)₂ is attached to C that is connected to X; each Z independently is a side chain of an amino acid; and n is an integer selected from 1, 2, 3, 4, 5, 6, 7 and 8.

Aspect 22. A scale inhibitor composition comprising a polyalkyl phosphonated polyol ether having a structure represented by Formula II as disclosed herein, wherein, each R1 and R2 is independently selected from —H, —OR5, and —CH₂OH; R3 is absent or —CH₂— and when R3 is absent, O is attached to C that is connected to R1 and R2; each R4 is independently selected from —H, —CH₃, —CH₂CH₂OH, —CHZCO₂H, and —CH₂P(O)(OH)₂, wherein at least one R4 is —CH₂P(O)(OH)₂; each R5 is independently H or —CH₂CH(OH)CH₂N(R4)₂; each X independently is absent or —NHCH₂CH₂— and when X is absent, N(R4)₂ is attached to C that is connected to X; each Z independently is a side chain of an amino acid; and n is an integer selected from 1, 2, 3, 4, 5, 6, 7 and 8.

Aspect 23. The scale inhibitor composition of Aspect 22, wherein n is 4, at least two R1 are —OR5, each R5 is —CH₂CH(OH)CH₂N(R4)₂, and at least four R4 are —CH₂P(O)(OH)₂.

Aspect 24. The scale inhibitor composition of Aspect 23, wherein at least six R4 are —CH₂P(O)(OH)₂.

Aspect 25. A scale inhibitor composition comprising a polyalkyl phosphonated polyol ether having a structure represented by Formula IIa, IIb, or IIc as disclosed herein, wherein, each R4 is independently —H or —CH₂P(O)(OH)₂, wherein at least one R4 is —CH₂P(O)(OH)₂; each R5 independently is H or —CH₂CH(OH)CH₂N(R4)₂; and each X independently is absent or —NHCH₂CH₂— and when X is absent, (NR4)₂ is attached to C that is connected to X.

Aspect 26. The scale inhibitor composition of Aspect 25, wherein the polyalkyl phosphonated polyol ether has a structure represented by Formula IIa, wherein, each R5 is H or —CH₂CH(OH)CH₂N(R4)₂ and at least four R4 are —CH₂P(O)(OH)₂.

Aspect 27. The scale inhibitor composition of one of Aspect 25 of 26, wherein at least six R4 are —CH₂P(O)(OH)₂.

Aspect 28. The scale inhibitor composition of Aspect 26, wherein each R4 is —CH₂P(O)(OH)₂.

Aspect 29. A scale inhibitor composition comprising a polyalkyl phosphonated polyol ether having a structure represented by Formula IIa1, IIa2, IIa3, IIa4, IIb1, or IIc1 as disclosed herein, wherein, each R4 is independently —H or —CH₂P(O)(OH)₂, wherein at least one R4 is —CH₂P(O)(OH)₂.

Aspect 30. The scale inhibitor composition of Aspect 29, wherein the polyalkyl phosphonated polyol ether has the structure represented by Formula IIa1 or Formula IIa2 and at least 4 of R4 are —CH₂P(O)(OH)₂.

Aspect 31. The scale inhibitor composition of Aspect 30, wherein each R4 is —CH2P(O)(OH)2.

Aspect 32. The scale inhibitor composition of Aspect 29, wherein the polyalkyl phosphonated polyol ether has the structure represented by Formula IIa1, IIa2, IIa3, IIa4, IIb1, or IIc1 and at least 2 R4 are —CH₂P(O)(OH)₂.

Aspect 33. The scale inhibitor composition of Aspect 32, wherein each R4 is —CH₂P(O)(OH)₂.

Aspect 34. The scale inhibitor composition of any one of Aspects 29 to 33, wherein the scale inhibitor composition includes greater than 20 wt % polyalkyl phosphonated polyol ether having structure represented by Formula IIa1 or IIa2 and at least 4 of R4 are —CH2P(O)(OH)2.

Aspect 35. The scale inhibitor composition of any one of Aspects 21 to 34, wherein the scale inhibitor composition includes the polyalkyl phosphonated polyol ether in a range of about 10 wt % to about 90 wt % based on a total weight of the scale inhibitor composition.

Aspect 36. An aqueous fluid comprising: water; and the scale inhibitor composition of any one of Aspects 21 to 35.

Aspect 37. The aqueous fluid of Aspect 36, wherein a concentration of the polyalkyl phosphonated polyol ether in the aqueous fluid is in a range of from about 1 ppmw to about 10,000 ppmw, alternatively from about 1 ppmw to about 1,000 ppmw, alternatively from about 1 ppmw to about 100 ppmw, alternatively from about 1 ppmw to about 50 ppmw, based on a total weight of the aqueous fluid.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular aspects of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or steps.

1. A scale inhibitor composition comprising a polyalkyl phosphonated polyol ether having a structure represented by Formula I: 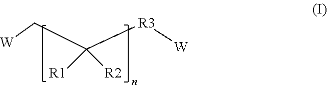
wherein,
each W is —OH or 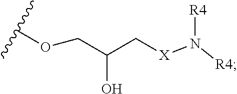
each R1 and R2 is independently selected from —H, —W, and —CH₂OH;
R3 is absent or —CH₂— and when R3 is absent, O is attached to C that is connected to R1 and R2;
each R4 is independently selected from —H, —CH₃, —CH₂CH₂OH, —CHZCO₂H, and —CH₂P(O)(OH)₂, wherein at least one R4 is —CH₂P(O)(OH)₂;
each X independently is absent or —NHCH₂CH₂— and when X is absent, N(R4)₂ is attached to C that is connected to X;
each Z independently is a side chain of an amino acid; and
n is an integer selected from 1, 2, 3, 4, 5, 6, 7 and 8,
wherein when W is —OH and R3 is absent, R1 and R2 are not —H;
wherein when R1 and R2 are H and R3 is absent, W is not —OH;
wherein when R3 is absent, W is not —OH or R1 and R2 are not —H.

2. A scale inhibitor composition comprising a polyalkyl phosphonated polyol ether having a structure represented by Formula II: 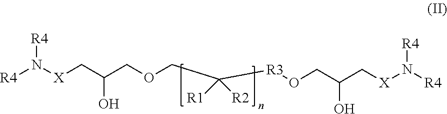
wherein,
each R1 and R2 is independently selected from —H, —OR5, and —CH₂OH;
R3 is absent or —CH₂— and when R3 is absent, O is attached to C that is connected to R1 and R2;
each R4 is independently selected from —H, —CH₃, —CH₂CH₂OH, —CHZCO₂H, and —CH₂P(O)(OH)₂, wherein at least one R4 is —CH₂P(O)(OH)₂;
each R5 is independently H or —CH₂CH(OH)CH₂N(R4)₂;
each X independently is absent or —NHCH₂CH₂— and when X is absent, N(R4)₂ is attached to C that is connected to X;
each Z independently is a side chain of an amino acid; and
n is an integer selected from 1, 2, 3, 4, 5, 6, 7 and 8.

3. The scale inhibitor composition of claim 2, wherein n is 4, at least two R1 are —OR5, each R5 is —CH₂CH(OH)CH₂N(R4)₂, and at least four R4 are —CH₂P(O)(OH)₂.

4. The scale inhibitor composition of claim 3, wherein at least six R4 are —CH₂P(O)(OH)₂.

5. A scale inhibitor composition comprising a polyalkyl phosphonated polyol ether having a structure represented by Formula IIa, IIb, or IIc: 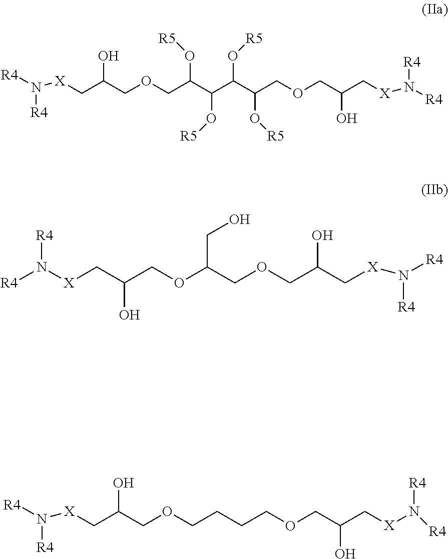
wherein,
each R4 is independently —H or —CH₂P(O)(OH)₂, wherein at least one R4 is —CH₂P(O)(OH)₂;
each R5 independently is H or —CH₂CH(OH)CH₂N(R4)₂; and
each X independently is absent or —NHCH₂CH₂— and when X is absent, (NR4)₂ is attached to C that is connected to X.

6. The scale inhibitor composition of claim 5, wherein the polyalkyl phosphonated polyol ether has a structure represented by Formula IIa: 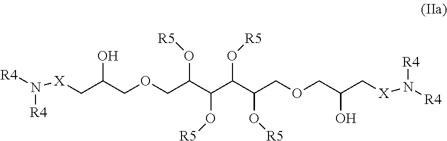
wherein,
each R5 is H or —CH₂CH(OH)CH₂N(R4)₂ and at least four R4 are —CH₂P(O)(OH)₂.

7. The scale inhibitor composition of claim 6, wherein at least six R4 are —CH₂P(O)(OH)₂.

8. The scale inhibitor composition of claim 6, wherein each R4 is —CH₂P(O)(OH)₂.

9. A scale inhibitor composition comprising a polyalkyl phosphonated polyol ether having a structure represented by Formula Hal, IIa2, IIa3, IIa4, IIb1, or IIc1: 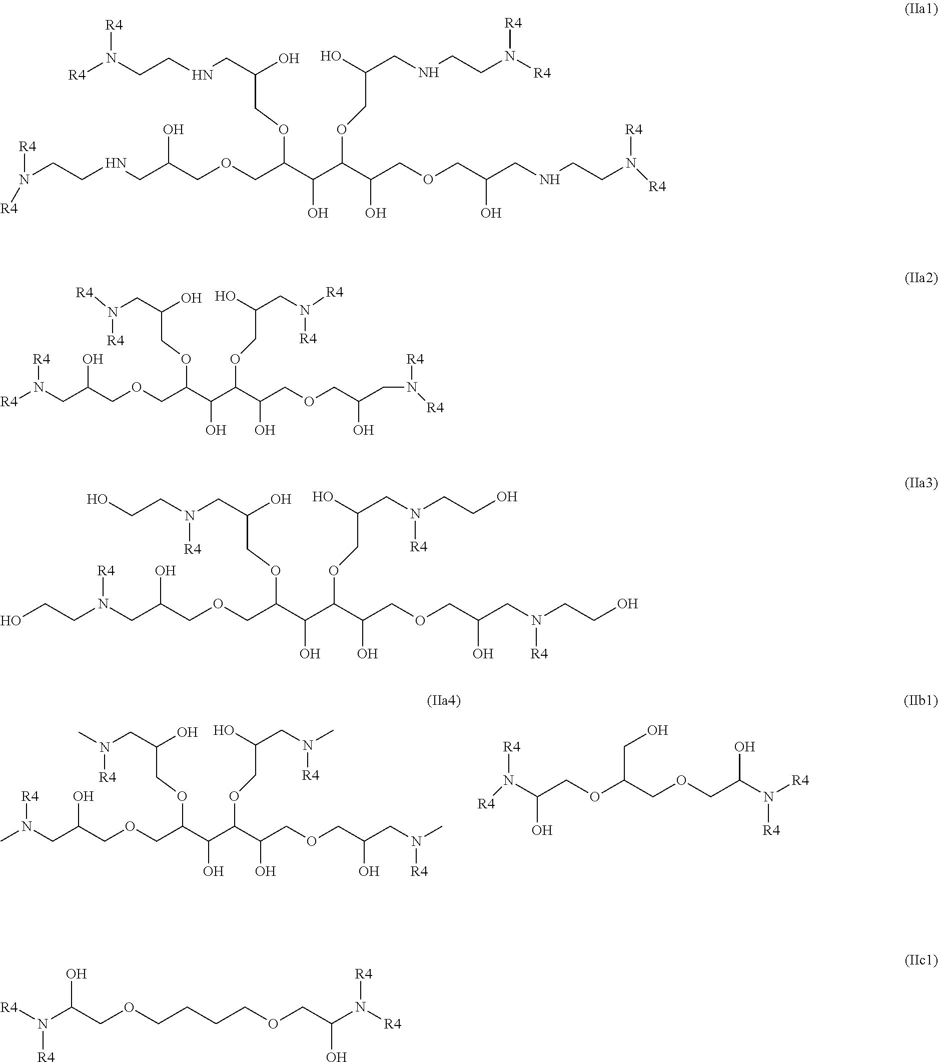
wherein,
each R4 is independently —H or —CH₂P(O)(OH)₂, wherein at least one R4 is —CH₂P(O)(OH)₂.

10. The scale inhibitor composition of claim 9, wherein the polyalkyl phosphonated polyol ether has the structure represented by Formula Hal or Formula IIa2 and wherein: i) at least 4 of R4 are —CH₂P(O)(OH)₂ or ii) each R4 is —CH₂P(O)(OH)₂.

11. (canceled)

12. The scale inhibitor composition of claim 9, wherein the polyalkyl phosphonated polyol ether has the structure represented by Formula Hal, IIa2, IIa3, IIa4, IIb1, or IIc1 and at least 2 R4 are —CH₂P(O)(OH)₂.

13. The scale inhibitor composition of claim 12, wherein each R4 is —CH₂P(O)(OH)₂.

14. The scale inhibitor composition of claim 9, wherein the scale inhibitor composition includes greater than 20 wt % polyalkyl phosphonated polyol ether having structure represented by Formula Hal or IIa2 and at least 4 of R4 are —CH₂P(O)(OH)₂.

15. The scale inhibitor composition of claim 1, wherein the scale inhibitor composition includes the polyalkyl phosphonated polyol ether in a range of about 10 wt % to about 90 wt % based on a total weight of the scale inhibitor composition.

16. An aqueous fluid comprising:
water; and
the scale inhibitor composition of claim 1.

17. The aqueous fluid of claim 16, wherein a concentration of the polyalkyl phosphonated polyol ether in the aqueous fluid is in a range of from about 1 ppmw to about 100 ppmw based on a total weight of the aqueous fluid.

18. A method of inhibiting scale, comprising:
contacting an aqueous fluid with the scale inhibitor composition of claim 1.

19. The method of claim 18, wherein a concentration of the polyalkyl phosphonated polyol ether is in a range of from about 1 ppmw to about 100 ppmw based on a total weight of the aqueous fluid.

20. The method of claim 18, further comprising:
i) introducing the scale inhibitor composition into a subterranean formation via a wellbore;
ii) producing a production fluid from a subterranean formation via a production wellbore; and introducing the scale inhibitor composition into the subterranean formation via an injection wellbore or into the production fluid in the production wellbore, optionally while the production fluid is flowing in the production wellbore; or
iii) receiving a production fluid from a wellbore; and introducing the scale inhibitor composition into the production fluid.

21. The method of claim 20, further comprising:
prior to introducing the scale inhibitor composition into a subterranean formation via a wellbore, stopping production of a production fluid from the wellbore.

22. (canceled)

23. (canceled)
